(19) United States
(12) Patent Application Publication
(10) Pub. No.: US 2026/0221363 A1
(43) Pub. Date: Jul. 30, 2026

(54) ELECTROMAGNETIC DRIVE UNIT

(71) Applicant: EATON INTELLIGENT POWER LIMITED, Dublin 4 (IE)

(72) Inventors: Saurabh Jayantilal BAROT, Maharashtra (IN); Vinaya Ashwin AMBEKAR, Maharashtra (IN)

(21) Appl. No.: 19/145,981

(22) PCT Filed: Dec. 27, 2023
(86) PCT No.: PCT/EP2023/025558

§ 371 Date: Jul. 7, 2025

(30) Foreign Application Priority Data
Jan. 27, 2023 (IN) 202311005332
Mar. 14, 2023 (GB) 2303737.7

(51) Int. Cl. H01H 51/22; H01F 7/14; H01H 50/54; H01H 50/56

(52) U.S. Cl. CPC H01H 51/2227; H01F 7/14; H01H 50/546; H01H 50/56

(57) ABSTRACT

Some embodiments relate to an electromagnetic drive unit with an armature, a yoke and a first coil. The armature is pivot-mounted and included a first armature-magnetic contact region. The yoke includes a first yoke-magnetic contact region and a second yoke-magnetic contact region, the first yoke-magnetic contact region includes a first contact area and the second yoke-magnetic contact region included a second contact area, in a first state of the electromagnetic drive unit the first armature-magnetic contact region being in touch with the first contact area, and in a second state of the electromagnetic drive unit the first armature-magnetic contact region being in touch with the second contact area. The first magnetic holding torque in the first state can be higher than a second magnetic holding torque in the second state.

### CROSS-REFERENCE TO RELATED APPLICATIONS

This application is a national phase filing under 35 C.F.R. § 371 of and claims priority to PCT Patent Application No. PCT/EP2023/025558, filed on Dec. 27, 2023, which claims the priority benefit under 35 U.S.C. § 119 of Indian Patent Application number 202311005332, filed on Jan. 27, 2023, and British Patent Application No. 2303737.7, filed on Mar. 14, 2023, the contents of which are hereby incorporated in their entireties by reference.

The present disclosure relates to an electromagnetic drive unit according to the generic part of claim 1.

Electromagnetic relays are well-known and part of lots of electric devices. Even in times of semiconductor switching elements, classic mechanic relays have the advantage of lower resistance and lower dissipated energy.

Electromagnetic relays are part of hybrid switchgears, especially part of hybrid circuit breakers (HCB). Hybrid switchgear contain a semiconductor switching unit, which is shunted by a relay. This relay is typically called bypass relay. In normal operation, the contacts of the bypass relay are closed and the semiconductor switching unit is typically in non-conductive mode. The current passing the switchgear flows through the low resistance bypass relay. A hybrid circuit breaker according to this concept is described in WO2015/028634 by the applicant.

In case of a short circuit switch-off operation, the contacts of the bypass relay must be opened as fast as possible. The faster the contact opening operation, the faster the current commutates to the semiconductor switching unit. Fast opening bypass relays enable the semiconductor switching unit to switch off a rising current at a lower level, compared to slower contact opening. If the operations ability for switching off high currents is not necessary for the semiconductor switching unit, the complete semiconductor switching unit can be realized with semiconductor elements having lower maximum current capability. Such semiconductors are physically smaller compared to high current semiconductors. They have lower resistance and heat dissipation, and they cause a lower loop inductance of the semiconductor switching unit, which results in a lower current commutation time.

The contact opening time or speed of the bypass relay is a central point in the design of a hybrid circuit breaker. This time and/or this speed limits the minimization of the complete switchgear. The real contact opening time of the bypass relay has a direct influence on most other parts, especially the necessary power rating of the semiconductors. A slow bypass relay requires a semiconductor switching unit with a high power rating. As semiconductors with high power rating have greater volumes, the contact opening time of the bypass relay is the most influencing factor for the total volume of hybrid switchgear.

The contact opening time is partly influenced by the electromagnetic drive unit of the relay and the mechanical design of the relay. The WO 2021/008991 A1 of the applicant shows a special design of the mechanical connection of the electromagnetic drive unit of a relay and the movable electrical contacts of the relay.

It is an object of the presently disclosed subject matter to overcome the drawbacks of the state of the art by providing an electromagnetic drive unit for a relay, especially a bypass relay of a HCB, with reduced and/or very low contact opening times.

According to the presently disclosed subject matter, the aforementioned object is solved by the features of claim 1.

The magnetic holding torque of the electromagnetic drive unit is a part that influences the opening time of a relay. As a result, the magnetic holding torque could be used to reduce the opening time. The change in the design of the yoke-magnetic contact regions is much easier to implement in manufacturing and much more cost-effective as a more intensive permanent magnet.

As a result, the electromagnetic drive unit can open a relay in a very short time. The electromagnetic drive unit according to the presently disclosed subject matter does not need more space than the electromagnetic drive unit according to WO 2021/008991 A1, but the opening time is shorter in the range of 10%-20%.

The dependent claims describe further preferred embodiments of the presently disclosed subject matter.

The presently disclosed subject matter is described with reference to the drawings. The drawings show only exemplary embodiments of the presently disclosed subject matter.

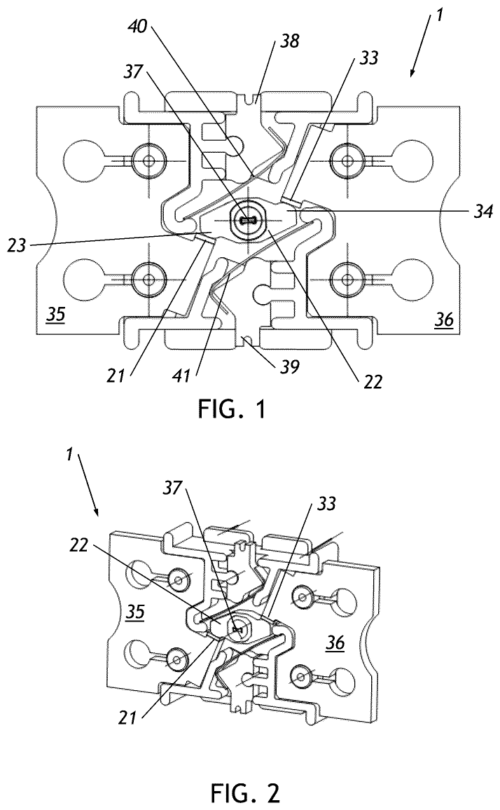

FIG. 1 illustrates an open front side of a relay for an electromagnetic drive unit according to the presently disclosed subject matter;

FIG. 2 shows the relay according to FIG. 1 in axonometric view;

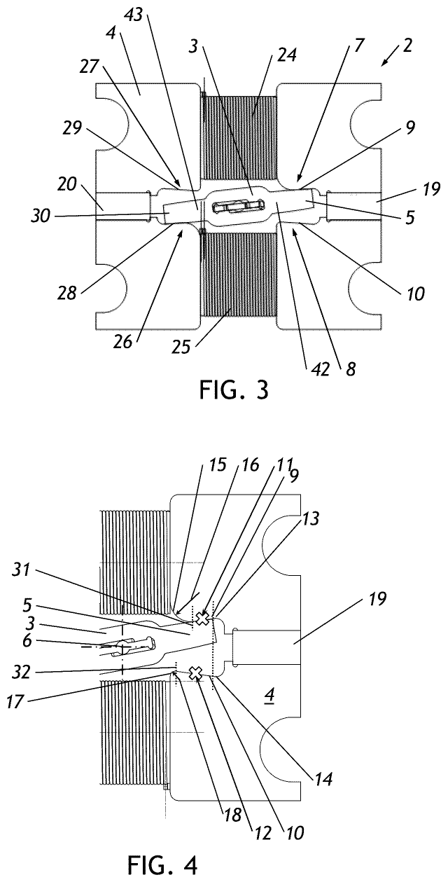

FIG. 3 illustrates a first preferred embodiment of an electromagnetic drive unit in the first state;

FIG. 4 shows a detail of the electromagnetic drive unit according to FIG. 3;

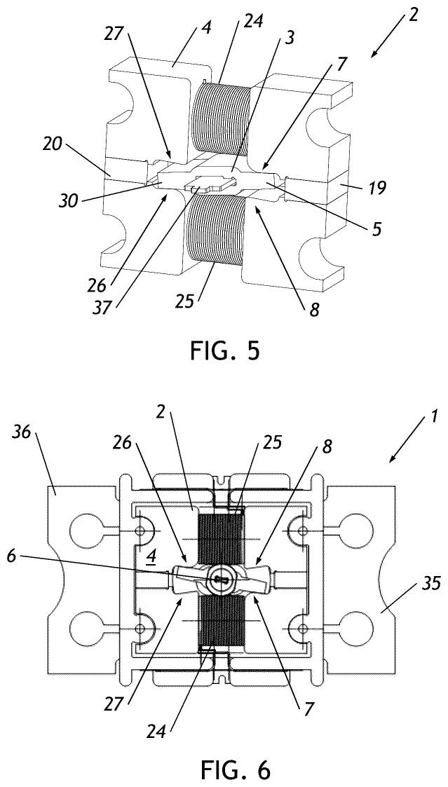

FIG. 5 shows the electromagnetic drive unit according to FIG. 3 in axonometric view;

FIG. 6 illustrates a rear view of the relay according to FIG. 1 with a second preferred embodiment of an electromagnetic drive unit;

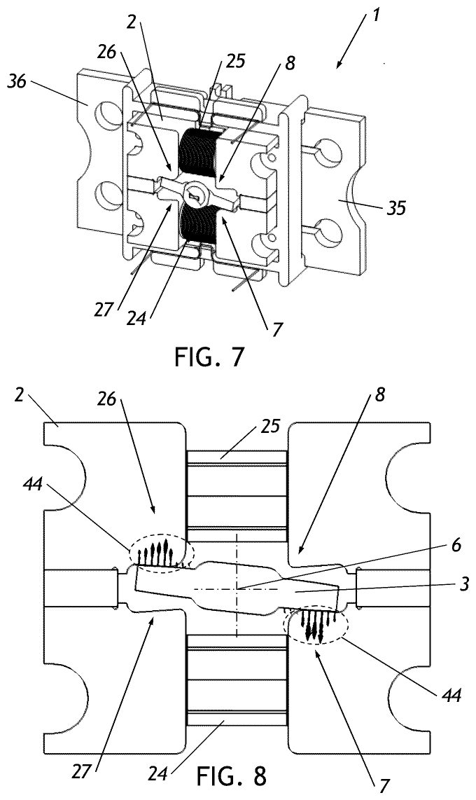

FIG. 7 the relay according to FIG. 6 in axonometric view;

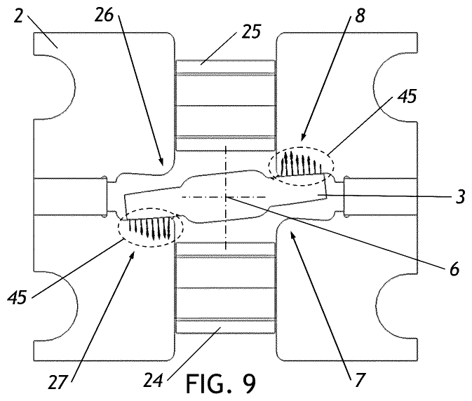

FIG. 8 shows the electromagnetic drive unit in ON-state;

FIG. 9 shows the electromagnetic drive unit in OFF-state;

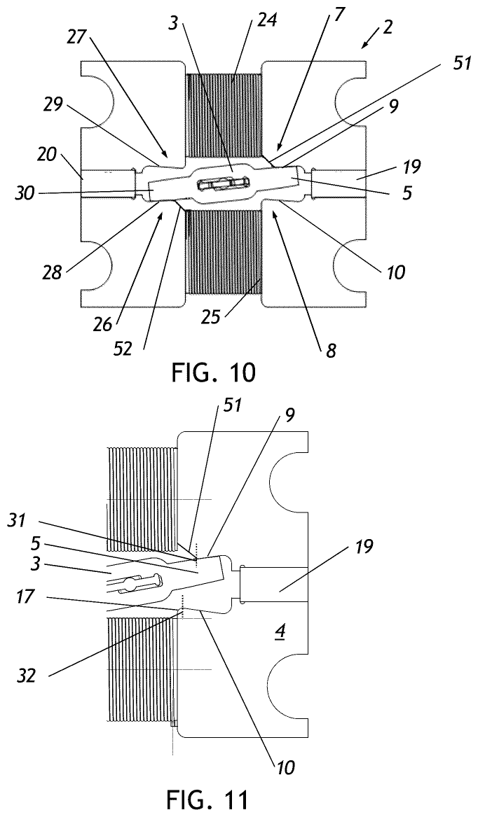

FIG. 10 illustrates a second preferred embodiment of an electromagnetic drive unit in the first state; and

FIG. 11 shows a detail of the electromagnetic drive unit according to FIG. 10.

FIGS. 3 to 7, 10 and 11 illustrate at least partly preferred embodiments of an electromagnetic drive unit 2, particularly for a relay 1. The electromagnetic drive unit 2 comprises an armature 3, a yoke 4, a first permanent magnet 19 and a first coil 24. The armature 3 is pivot-mounted around a predefined rotational axis 6. The armature 3 comprises a first armature-magnetic contact region 5. The yoke 4 comprises a first yoke-magnetic contact region 7 and a second yoke-magnetic contact region 8. The first yoke-magnetic contact region 7 comprises a first contact area 9 and the second yoke-magnetic contact region 8 comprises a second contact area 10. In a first state of the electromagnetic drive unit 2, the first armature-magnetic contact region 5 is in touch with the first contact area 9, and in a second state of the electromagnetic drive unit 2, the first armature-magnetic contact region 5 is in touch with the second contact area 10. The first yoke-magnetic contact region 7 and the second yoke-magnetic contact region 8 are formed in such a way that a first magnetic holding torque in the first state is higher than a second magnetic holding torque in the second state.

The magnetic holding torque of the electromagnetic drive unit is a part that influences the opening time of a relay. As a result, the magnetic holding torque could be used to reduce the opening time. The change of the design of the yoke-magnetic contact regions is much easier to implement in manufacturing and much more cost-effective as a more intensive permanent magnet.

As a result, the electromagnetic drive unit can open a relay in a very short time. The electromagnetic drive unit according to the presently disclosed subject matter does not need more space than the electromagnetic drive unit according to WO 2021/008991 A1, but the opening time is shorter in the range of 10%-20%.

The electromagnetic drive unit 2 is preferably a part of a relay 1, especially a relay 1 for low voltage applications. The relay 1 is especially intended for use as bypass relay in a hybrid circuit breaker comprising at least a semiconductor switching unit and a bypass relay, with the bypass relay arranged in parallel to the semiconductor switching unit. A hybrid circuit breaker according to this concept is for example described in WO2015/028634 by the applicant. Preferably the bypass relay is embodied as relay 1 according to the presently disclosed subject matter.

The electromagnetic drive unit 2 comprises an armature 3 and a yoke 4.

The yoke 4 comprises a first yoke-magnetic contact region 7 and a second yoke-magnetic contact region 8. The first yoke-magnetic contact region 7 comprises a first contact area 9 and the second yoke-magnetic contact region 8 comprises a second contact area 10. According to the preferred embodiments, the second yoke-magnetic contact region 8 is arranged on an opposite side of the first yoke-magnetic contact region 7.

The electromagnetic drive unit 2 further comprises at least a first coil 24, wound at least partly around an area of the yoke 4. According to the preferred embodiment, the electromagnetic drive unit 2 further comprises a second coil 25, wound at least partly around an area of the yoke 4. In this preferred embodiment, the first and the second yoke-magnetic contact regions 7, 8 are arranged in an area between the first and the second coils 24, 25.

The electromagnetic drive unit 2 further comprises at least a first permanent magnet 19, which is arranged between two parts of the yoke 4. Especially the first permanent magnet 19 is arranged between the first yoke-magnetic contact region 7 and the second yoke-magnetic contact region 8. According to the preferred embodiment, the electromagnetic drive unit 2 further comprises a second permanent magnet 24, which is also arranged between two parts of the yoke 4.

According to the preferred embodiment, as shown in FIGS. 3, 5, 6 and 7, the arrangement comprising the yoke 4, the first and second coil 24, 25 and the first and second permanent magnet 19, 20 is essentially symmetric.

The armature 3 is pivot-mounted around a predefined rotational axis 6. The armature 3 comprises at least a first arm 42, with the first arm 42 embodied as first armature-magnetic contact region 5 to get in touch with the first yoke-magnetic contact region 7 and the second yoke magnetic contact-region 8 of the yoke 4. The first magnetic contact region 5 comprises preferably both sides of the first arm. In the first stage of the electromagnetic drive unit 2, the first armature-magnetic contact region 5 is in touch with the first contact area 9. In the second stage of the electromagnetic drive unit 2, the first armature-magnetic contact region 5 is in touch with the second contact area 10. As described, the electromagnetic drive unit 2 is mechanically connected with a switching arrangement of the relay 1. The relay 1 has two different switching states: switched ON and switched OFF. In the ON state of the relay 1, the electromagnetic drive unit 2 is in the first state. In the OFF state of the relay 1, the electromagnetic drive unit 2 is in the second state.

According to the preferred embodiment, the yoke 4 comprises a further magnetic contact region on an opposite side of the first yoke-magnetic contact region 7 and the second yoke-magnetic contact region 8. This further magnetic contact region comprises a third yoke-magnetic contact region 26 with a third contact area 28, and a fourth yoke-magnetic contact region 27 with a fourth contact area 29.

According to the preferred embodiment as shown in FIGS. 3, 5, 6, 7, 8, 9, 10 and 11, the armature 3 comprises a second arm 43, with the second arm 43 embodied as second armature-magnetic contact region 30. Preferably, the armature 3 is embodied as point-symmetric. Another word for point symmetry is central symmetry. In the first state of the electromagnetic drive unit 2, the second armature-magnetic contact region 30 is in touch with the third yoke-magnetic contact region 26. In the second state of the electromagnetic drive unit 2, the second armature-magnetic contact region 30 is in touch with the fourth yoke-magnetic contact region 27.

According to the presently disclosed subject matter, the first yoke-magnetic contact region 7 and the second yoke-magnetic contact region 8 are formed and/or arranged in such a way that a magnetic holding torque in the first state is higher than a magnetic holding torque in the second state.

In the further description, the presently disclosed subject matter is described with the first and the second yoke-magnetic contact regions 7, 8 and the first armature-magnetic contact region 5. All described features and/or details are also part of the preferred embodiment comprising the third and the fourth yoke-magnetic contact region 26, 27 and the second armature-magnetic contact region 30.

According to a first embodiment of the electromagnetic drive unit 2, the different magnet holding torques are achieved with different designs of the two contact areas 9, 10.

A contact area has a center independent of the geometry of the contact area. Preferably, a first perpendicular distance from the rotational axis 6 to the first center 11 or the first centroid of the first contact area 9 is larger than a second perpendicular distance from the rotational axis 6 to the second center 12 or the second centroid of the second contact area 10. The first and the second centers 11, 12 are illustrated as crosses in FIG. 4. As a result, the magnet holding torque at the first yoke-magnetic contact region 7 would be higher than that at the second yoke-magnetic contact region 8, even if the resultant magnetic forces of the first magnetic forces 44 and the second magnetic forces 45 would be identical.

According to a preferred embodiment, the surface of the first contact area 9 is smaller than the surface of the second contact area 10. In a preferred embodiment, the surface area of the first contact area 9 is 55%-80%, particularly 60%-75%, especially about 70%, of the surface area of the second contact area 10. As a result, the first magnetic forces 44 in the smaller first contact area 9 are higher than the second magnetic forces 45 in the larger second contact area 10. FIGS. 8 and 9 show the different first and second magnetic forces 44, 45 in ON-state and OFF-state.

The first and the second contact areas 9, 10 can have different forms. According to a further preferred embodiment, each of the first contact area 9 and the second contact area 10 have the form of a flat rectangle. This would be advantageous from manufacturing point-of-view. Preferably the rectangles of the first contact area 9 and the second contact area 10 have essentially the same width. The first length of the first contact area 9 is shorter than the second length of the second contact area 10. This is a practical and simple realisation of different surfaces of the first and the second contact areas 9, 10.

Preferably, the first and the second contact area 9, 10 are flat areas. The flat areas may be circular, rectangular, elliptical or of any other geometry in shape. The geometry of the first and/or the second contact area 9, 10 may also comprise a combination of flat areas and lines and/or points due to manufacturing irregularities.

In addition, to the features regarding the surface of the contact areas 9, 10, also their positions have an influence on the magnetic holding torque, since torque is the resultant force multiplied by the perpendicular distance.

According to a further development of the contact areas 9, 10, a first outer end 13 of the first contact area 9 has the same distance from the rotational axis 6 as a second outer end 14 of the second contact area 10. The first and the second outer ends 13, 14 are illustrated as dotted lines in FIG. 4. As a result, the first perpendicular distance would be definitely larger than the second perpendicular distance.

According to a second embodiment of the electromagnetic drive unit 2, the magnet holding torques could be influenced by the design of inner parts of the yoke-magnetic contact regions 7, 8. The different magnet-holding torques could be obtained by different designs of the inner parts of the yoke-magnetic contact regions 7, 8.

According this second embodiment, the first yoke magnetic contact-region 7 comprises a first transitional edge arranged next to a first inner end 31 of the first contact area 9. The second yoke-magnetic contact region 8 comprises a second transitional edge arranged next to a second inner end 32 of the second contact area 10. The inner parts are nearer to the rotational axis 6 than the contact areas. The first and the second transitional edges would preferably be embodied as rounded edges, as flat areas, as a combination of short flat areas, as combination of short rounded edges, or as combination of rounded edges and flat areas. The first transitional edge is larger than the second transitional edge.

According to a preferred embodiment, the first transitional edge is embodied as a first rounded edge 15 with a first radius 16, and the second transitional edge is embodied as a second rounded edge 17 with a second radius 18. The first rounded edge 15 is arranged next to a first inner end 31 of the first contact area 9. The second rounded edge 17 is arranged next to a second inner end 32 of the second contact area 10. In other words, the contact areas 9, 10 end individually at that points where the rounded edges 15, 17 begin. The first radius 16 is larger than the second radius 18. The larger first radius 16 is helpful for the magnetic flux in the first yoke-magnetic contact region 7. The magnetic field would be concentrated to the first contact area 9 and the magnetic flux density and the first magnetic forces 44 rises.

Preferably, the second radius 18 is 30%-55%, particularly about 40%-45%, especially 43%, of the first radius 16, or, the first radius 16 is 2.2 to 2.9 times, particularly about 2.5 times, the size of the second radius 18. For example, the first radius 16 could be between 0.8 mm and 0.9 mm, and the second radius 18 could be between 0.32 mm and 0.36 mm.

FIGS. 10 and 11 show another preferred embodiment. In this embodiment, the first transitional edge is embodied as a first chamfer 51. Further, in a third yoke-magnetic contact region 26 the transitional edge would be embodied as a second chamfer 52.

According to a third embodiment of the electromagnetic drive unit 2, features, especially all features, of the first embodiment of the electromagnetic drive unit 2 and features, especially all features, of the second embodiment of the electromagnetic drive unit 2 are combined. The FIGS. 3 to 6 show an electromagnetic drive unit 2 according to the third embodiment.

FIGS. 1, 2, and 7 show a relay with the electromagnetic drive unit 2 according to the presently disclosed subject matter. The relay 1 further comprises at least an immovable first electric contact 21 and a moveable contact arm 22 with at least a second electric contact 23. The immovable first electric contact 21 is arranged on a first contact piece 35 of the relay 1, which comprises at least one opening for external connection.

According to the preferred embodiment, the relay 1 is an inversion through a point, comprising an immovable third electric contact 33. Further, the contact arm 22 is point-symmetric and comprises a movable fourth electric contact 34. The immovable third electric contact 33 is arranged on a second contact piece 36 of the relay 1, which comprises at least one opening or a soldering log for external connection.

The moveable contact arm 22 is mechanically connected to the rotatable armature 3 with a flat spring 37, the first electric contact 21 contacts the second electric contact 23 in the first state of the electromagnetic drive unit 2. Details of a flat spring 37 are described in the WO 2021/008991 A1 by the applicant.

According to a further preferred embodiment, the relay 1 comprises an auxiliary electric path for a first auxiliary contact piece 38 to a second auxiliary contact piece 39. The relay 1, especially the auxiliary electric path, contains at least one auxiliary spring 40, 41, which is also an electric contact element. The auxiliary spring 40, 41 biases the contact arm 22 in direction of the immovable first electric contact 21 in the second state, in which second state the second electric contact 23 is spaced apart from the immovable first electric contact 21. According to the preferred embodiment, the relay 1 comprises a first auxiliary spring 40 and a second auxiliary spring 41. The auxiliary springs 40, 41 further support the electromagnetic drive unit 2 for bringing the contact arm 22 from the second state to the first state.

As partially already described, the actual relay 1 is configured to be in two different stable states. The first stable state is defined as a switched-ON state. In this state, the electric contacts 21, 23, 33, 34 are closed, particularly, contacted, and an electric current flow through the relay 1 is enabled. The second stable state is defined as a switched-OFF state. In this state, the electric contacts 21, 23, 33, 34 are opened, particularly, separated, and an electric current flow through the relay 1 is disabled.

While the presently disclosed subject matter has been particularly shown and described with reference to exemplary embodiments thereof, it will be understood by those skilled in the art that various changes in form and details may be made therein without departing from the spirit and scope of the presently disclosed subject matter as defined by the appended claims. The exemplary embodiments should be considered as descriptive only and not for purposes of limitation. Therefore, the scope of the presently disclosed subject matter is not defined by the detailed description but by the appended claims.

Hereinafter are principles for understanding and interpreting the actual disclosure.

Features are usually introduced with an indefinite article “one, a, an”. Unless otherwise stated in the context, therefore, “one, a, an” is not to be understood as a numeral.

The conjunction “or” has to be interpreted as inclusive and not as exclusive, unless the context dictates otherwise. “A or B” also includes “A and B”, where “A” and “B” represent random features.

By means of an ordering number word, for example “first”, “second” or “third”, in particular a feature X or an object Y is distinguished in several embodiments, unless otherwise defined by the disclosure of the presently disclosed subject matter. In particular, a feature X or object Y with an ordering number word in a claim does not mean that an embodiment of the presently disclosed subject matter covered by this claim must have a further feature X or another object Y.

An “essentially” in conjunction with a numerical value includes a tolerance of ±10% around the given numerical value, unless the context dictates otherwise.

For ranges of values, the endpoints are included, unless the context dictates otherwise.

1. An Electromagnetic drive unit, for a relay, the electromagnetic drive unit comprising:
an armature;
a yoke;
a first permanent magnet;
and a first coil;
the armature being pivot-mounted around a predefined rotational axis,
the armature including a first armature-magnetic contact region,
the yoke including a first yoke-magnetic contact region and a second yoke-magnetic contact region, the first yoke-magnetic contact region including a first contact area and the second yoke-magnetic contact region includes a second contact area,
in a first state of the electromagnetic drive unit the first armature-magnetic contact region being in touch with the first contact area,
and in a second state of the electromagnetic drive unit the first armature-magnetic contact region being in touch with the second contact area,
wherein, that the first yoke-magnetic contact region and the second yoke-magnetic contact region are formed in such a way that a first magnetic holding torque in the first state is higher than a second magnetic holding torque in the second state.

2. An Electromagnetic drive unit according to claim 1, wherein, that the second yoke-magnetic contact region is arranged on an opposite side of the first yoke-magnetic contact region.

3. An Electromagnetic drive unit according to claim 1, wherein, that a first perpendicular distance from the rotational axis to a first center of the first contact area is larger than a second perpendicular distance from the rotational axis to a second center of the second contact area.

4. An Electromagnetic drive unit according to claim 1, wherein, that the surface area of the first contact area is smaller than the surface area of the second contact area.

5. An Electromagnetic drive unit according to claim 4, wherein, that the surface area of the first contact area is 55%-80%, particularly 60%-75%, especially about 70%, of the surface area of the second contact area.

6. An Electromagnetic drive unit according to claim 1, wherein, that the first contact area and the second contact area have the form of rectangles, that the first contact area and the second contact area have essentially the same width, and that the first length of the first contact area is shorter than the second length of the second contact area.

7. An Electromagnetic drive unit according to claim 6, wherein, that a first outer end of the first contact area has the same distance from the rotational axis as a second outer end of the second contact area.

8. An Electromagnetic drive unit according to claim 1, wherein, that the first yoke-magnetic contact region comprises a first transitional edge and that the second yoke-magnetic contact region includes a second transitional edge, that the first transitional edge is arranged next to a first inner end of the first contact area, that the second transitional edge is arranged next to a second inner end of the second contact area, and that the first transitional edge is larger than the second transitional edge.

9. An Electromagnetic drive unit according to claim 8, wherein, that the first transitional edge is embodied as a first rounded edge with a first radius, that the second transitional edge is embodied as a second rounded edge with a second radius, and that the first radius is larger than the second radius.

10. An Electromagnetic drive unit according to claim 9, wherein, that the second radius is 30%-55%, particularly about 40%-45%, especially 43%, of the first radius.

11. An Electromagnetic drive unit according to claim 8, wherein, that the first transitional edge is embodied as a first chamfer.

12. An Electromagnetic drive unit according to claim 1, wherein, that the first permanent magnet is arranged between the first yoke-magnetic contact region and the second yoke-magnetic contact region.

13. A Relay (1) comprising an electromagnetic drive unit according to claim 1, the relay including at least an immovable first electric contact and a moveable contact arm with at least a second electric contact, the moveable contact arm is mechanically connected to the rotatable armature with a flat spring, the first electric contact contacting the second electric contact in the first state of the electromagnetic drive unit.

14. A Hybrid circuit breaker comprising at least a semiconductor switching unit and a bypass-relay, with the bypass-relay arranged in parallel to the semiconductor switching unit, wherein, that the bypass-relay is embodied as relay according to claim 13.
